(19) United States
(12) Patent Application Publication
(10) Pub. No.: US 2025/0210885 A1
(43) Pub. Date: Jun. 26, 2025

(54) Ground Connection Apparatus

(71) Applicant: Illinois Tool Works Inc., Glenview, IL (US)

(72) Inventors: Norbert BARTONEK, Hodenhagen (DE); Thorsten NEUMANN, Hodenhagen (DE)

(21) Appl. No.: 18/983,868

(22) Filed: Dec. 17, 2024

(30) Foreign Application Priority Data
Dec. 20, 2023 (DE) 10 2023 136128.7

(51) Int. Cl. H01R 4/06; H01R 3/08

(52) U.S. Cl. CPC H01R 4/06; H01R 3/08; H01R 2201/26

(57) ABSTRACT

Disclosed is a ground-connection apparatus for coolant-conducting components in motor vehicles. The ground-connection apparatus includes a coolant-conducting component and an electrically conductive ground connector. The coolant-conducting component includes a housing which is not or only poorly electrically conductive and comprises a passage opening for receiving an electrically conductive rivet element. The electrically conductive ground connector can be connected at a first end to a ground and comprises at a second end an opening for the rivet element, in particular a blind rivet. The rivet element along its longitudinal axis comprises a cooling liquid contact portion, a fastening portion, and a ground connection portion. A first end of the rivet element forms the cooling liquid contact portion, which is arranged within the housing in such a way that it can contact a cooling liquid located in the housing in order to establish an electrical connection with a cooling liquid. The fastening portion is, in regions, tangentially surrounded by the housing in the region of the passage opening. The ground connection portion is connected to the ground connector in such a way that an electrical connection is established between the ground connector and the housing rivet element, and the rivet element is connected by deformation to the housing in the region of the passage opening via the fastening portion.

### RELATED APPLICATION

The present application claims the benefit of German Patent Application No. 10 2023 136128.7, filed Dec. 20, 2023, each titled “Ground-connection apparatus,” the contents of which are hereby incorporated by reference.

### BACKGROUND

The ground (abbreviated GND) is the reference potential for signal and operating voltages. The ground can in principle be any node of an electric circuit and can be used as a reference potential for establishing all voltages in this network. The ground is typically defined with the potential 0 V.

In motor vehicles having various on-board power systems, for example 48 V and 12 V for different applications, it is common to define different ground potentials. The ground potential is commonly defined as the medium voltage between a negative and positive on-board voltage. The components of an on-board power system are connected to a common ground. This is usually accomplished by ground belts having press-welded ends and compressed sleeves.

In the automobile and also in the case of motorcycles and bicycles, the ground potential is the body or the frame. As a conductive part which extends over the entire vehicle, it also serves as a return conductor for an on-board power system. Each consumer of this on-board power system is connected to the ground and thus only one line must be laid.

In motor vehicles, a potential, preferably a ground, is also assigned to the coolant circuit. The cooling circuit comprises components such as valves and valve housings, radiators, pumps, conduits, and reservoir tanks.

### SUMMARY

The present disclosure relates generally to a ground-connection apparatus, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates a side perspective view of a ground-connection apparatus.

FIG. 2 illustrates a cross-section of a ground-connection apparatus.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The disclosure relates to a ground-connection apparatus for coolant-conducting components, in particular in motor vehicles, a coolant-conducting component having a ground connection, as well as to a method for ground connection of coolant-conducting components.

The problem addressed by the disclosure is to provide an apparatus with which cooling liquid can also be simply connected to a common potential in a vehicle.

A further problem addressed by the disclosure is to provide an apparatus that, in addition to a safe, reliable electrical contact, seals the housing of a coolant-conducting component.

The disclosure further seeks to make the ground connection cost-efficient and fast.

According to the present disclosure, there is provided a ground-connection apparatus for coolant-conducting components in motor vehicles. The ground-connection apparatus comprises a coolant-conducting component having a housing which is not or only poorly electrically conductive and comprises a passage opening for receiving an electrically conductive rivet element, in particular a blind rivet, an electrically conductive ground connector, which can be connected at a first end to a ground and comprises at a second end an opening for the rivet element, wherein the rivet element along its longitudinal axis comprises a cooling liquid contact portion, a fastening portion, and a ground connection portion, wherein a first end of the rivet element forms the cooling liquid contact portion, which is arranged within the housing in such a way that it can contact a cooling liquid located in the housing in order to establish an electrical connection with a cooling liquid, and wherein the fastening portion is, in regions, tangentially surrounded by the housing in the region of the passage opening, and wherein the ground connection portion is connected to the ground connector in such a way that an electrical connection is established between the ground connector and the housing, and the rivet element is retained in the passage opening in that it has been deformed.

As used herein, “ . . . the rivet element is retained in the passage opening in that it has been deformed” means that the rivet element is connected by deformation to the housing in the region of the passage opening via the fastening portion.

A rivet is a plastically deformable cylindrical connecting element. Creating a riveted joint between flat pieces of material laid over one another at the joint is referred to as rivets. Rivets consist of a flat, wide rivet head and a narrow cylindrical rivet stem.

With a rivet joint, the connecting forces are redirected, and additional bending torques arise in the assembly. The formation of a rivet joint between flat pieces of material laid over one another at the joint is referred to as rivets.

Rivets are a simple and fast mechanical joining process. Only a commercially available rivet pin is required for the assembly. A riveter can be used for a high number of repetitions.

Rivet joints are used primarily in applications requiring high vibration resistance.

Furthermore, manufacturing costs can be reduced by rivet joints, as this can keep the packaging sizes for transport smaller.

In addition, rivet joints are lighter than welding or screw joints.

These properties of rivet joints are particularly advantageous for use in motor vehicles.

In the present ground-connection apparatus, an electrical connection of the cooling liquid and the ground is achieved by the rivet connection in the ground connection portion in addition to a mechanical connection from the housing to the ground connector. The rivet element presses the ground-connection apparatus against the housing and against itself so that an electrical contact is established. At the same time, the rivet element is arranged in the housing to be surrounded by cooling liquid.

This results in the advantage that only one rivet element is needed in order to create a suspension for the ground connection and an electrical contact to the coolant.

This results in the ground-connection apparatus according to the disclosure being vibration-resistant, inexpensively manufacturable, and quickly mountable.

Furthermore, the use of a rivet is space-saving, because only the rivet head projects outwards.

By using rivets, the installer can securely and reliably connect the ground-connection apparatus in one operating pass outside the housing. Thus, the ground connection is carried out by the ground-connection apparatus in a simple, externally accessible assembly layer.

In order to connect the entire cooling circuit to ground, the individual components of the cooling circuit are connected to ground. It is important to ensure that there is a common ground so that no equalizing currents arise among the components.

The cooling liquid can act as an electrical conductor, provided it contains electrically conductive constituents. Electrically conductive coolant should therefore be connected to a common ground with other coolant-conducting components.

Furthermore, coolant can come into contact with live conductors. It is therefore sensible to place its potential on ground so that any currents created can flow safely. A non-grounded coolant could come into contact with electrically conductive components in the event of a leak in the cooling circuit and cause damage by equalizing currents.

Furthermore, charged and leaking coolant would be a problem for persons who are in the vehicle or working on it.

The rivet element can be sealingly connected to an edge of the housing which delimits the passage opening by the deformation of the rivet element and/or by a sealing element, in particular an O-ring.

The rivet element deforms plastically during assembly within the housing. Thus, a type of plug forms, which seals the recess of the housing against leaking coolant.

The passage opening of the housing can be sealed by a sealing element, in particular an O ring, alone or as a supplement.

In addition to deformation of the rivet element, the sealing element provides protection against leaking coolant. However, it also ensures that nothing can penetrate the housing from the outside. Thus, a combination of deformation and sealing element is advantageous.

The housing can be configured in the region of the passage opening to have a sealing recess for receiving the sealing element, wherein a sub-portion of the fastening portion of the rivet element forms a sealing portion.

The ground connector can be formed from a sheet metal, in particular copper or aluminum, which can also be used for shielding purposes.

In motor vehicles, shielding panels are used in order to avoid unwanted coupling of electromagnetic waves in lines. Depending on which region in the vehicle is cooled, the cooling system can cause unwanted interference in other on-board power systems. For example, the coolant-conducting pumps can interfere with in-vehicle communications through internal switching operations. Shields or braids are typically connected to a ground.

If the ground connection assembly is configured as a shield, then the cooling circuit or other components can be shielded without the need for an additional suspension for a shield.

The ground-connection apparatus can be formed from an insulated cable and a cable lug.

In this way, the ground-connection apparatus can also be attached to regions in the vehicle that do not provide space for a sheet metal connection. The cable can be laid up to a remote ground rail.

The housing is manufactured from a plastic by means of a single-component injection molding process.

The housing can thus be manufactured quickly and conveniently in one work step.

The coolant-conducting components can be configured as valves, valve bodies, radiators, pumps, pipes, reservoir tanks, and/or battery housings.

The coolant-conducting components thus comprise the components that come into contact with cooling liquid.

In addition to the ground connector in the ground connection portion, other components independent of the coolant guidance can be connected to the ground by the rivet element.

In this way, space-saving surrounding components can be connected to a ground without the need to create additional connection points for a ground.

Furthermore, according to the present disclosure, a coolant-conducting component comprising a ground-connection apparatus according to the present disclosure is provided, which comprises a housing, a ground connector, and a rivet element. A first end of the rivet element forms the cooling liquid contact portion, which is arranged within the housing such that it can contact a cooling liquid located in the housing in order to establish an electrical connection with a cooling liquid. The fastening portion is tangentially surrounded by the housing in the region of the passage opening. The ground connection portion is connected to the ground connector such that an electrical connection is established between the ground connector and the housing. The rivet element is connected by deformation to the housing in the region of the passage opening via the fastening portion.

The advantages of the coolant-conducting component according to the disclosure correspond analogously to the advantages described above with respect to the apparatus according to the disclosure.

In addition, according to the present disclosure, a method for connecting coolant in coolant-conducting components to a ground comprising a ground-connection apparatus according to the present disclosure is provided, which comprises a housing, a ground connector, and a rivet element. A first end of the rivet element forms the cooling liquid contact portion, which is arranged within the housing such that it can contact a cooling liquid located in the housing in order to establish an electrical connection with a cooling liquid. The fastening portion is tangentially surrounded by the housing in the region of the passage opening. The ground connection portion is connected to the ground connector such that an electrical connection is established between the ground connector and the housing. The rivet element is connected by deformation to the housing in the region of the passage opening via the fastening portion.

The advantages of the method according to the disclosure correspond analogously to the advantages described above with respect to the apparatus according to the disclosure.

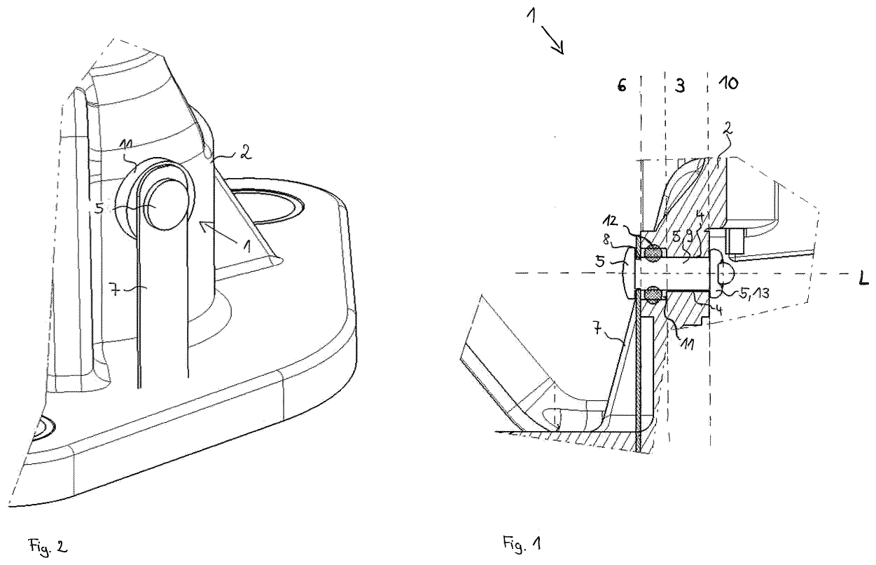

FIG. 1 illustrates a side perspective view of a ground-connection apparatus, while FIG. 2 illustrates a cross-section of a ground-connection apparatus.

According to the disclosure, a ground-connection apparatus 1 is arranged in a motor vehicle (not shown) on a ground rail (not shown) connected to the body of the motor vehicle. The ground rail is formed from an electrically conductive material and is comprised of a plurality of ground ports.

The ground-connection apparatus 1 is screwed onto, welded to, soldered to, or electrically conductively connected to the ground rail. Ground rails are preferably formed over a large surface area with a certain material strength in order to be able to absorb high currents.

The ground-connection apparatus 1 is configured for coolant-conducting components.

The coolant-conducting component comprises at least one space and/or a conduit for electrical passage or for storing cooling liquid. The coolant-conducting component is part of the cooling circuit. The coolant-conducting component can be configured as a valve, valve body, radiator, pump, conduit, reservoir tank, and/or battery housing.

The housing 2 of a coolant-conducting component is configured to guide cooling liquid in its interior. The housing 2 is formed from a material which is not or only poorly electrically conductive. This material is configured to be resistant against cooling liquid.

The housing in the present exemplary embodiment is manufactured from a plastic by means of a single-component injection molding process.

Furthermore, in a fastening portion 3, the housing 2 comprises an approximately circular passage opening 4 for a rivet element 5. Direct physical contact with the cooling liquid or the coolant is possible through this passage opening 4. In the fastening portion 3, the rivet element 5 is tangentially surrounded by the housing 2.

In a ground connection portion 6, the ground-connection apparatus 1 comprises a ground connector 7. This is made of an electrically conductive and moldable material, such as a copper sheet, aluminum sheet, aluminum tape, or the like.

The ground connector 7 is preferably shaped by bending, so that it is arranged tangentially on a housing 2 of the coolant-conducting component to be connected.

It is also possible for the ground connector 7 to be connected to the housing 2 from a cable, which is connected to a cable lug, the diameter of which is configured to receive a rivet element 5.

The ground connector 7 comprises an opening 8 for receiving the rivet element 5.

In the ground connection portion 6, the ground connector 7 establishes an electrical contact with the rivet element 5 in that the rivet element 5, in conjunction with the housing 2, presses the ground connector 7 against itself.

In an assembly layer, the ground connector 7 is mounted on the housing 2 from the outside.

The rivet element 5 is a plastically deformable cylindrical connecting element. It consists of a wide rivet sleeve 9 with a rivet head and a narrow rivet nail. Rivet elements 5 are formed from copper, chrome steel, aluminum, or alloys thereof. According to the disclosure, the rivet elements 5 are formed from an electrically conductive material. The outer diameter of the rivet element 5 corresponds approximately to the inner diameter of the passage opening 4.

In the present exemplary embodiment, the rivet element 5 is configured as a blind rivet. However, it is also contemplated that the rivet element 5 is configured as a countersunk head or semi-circular rivet or the like.

Along the longitudinal axis L of the rivet element 5, the ground connection portion 6, the fastening portion 3, and a cooling liquid contact portion 10 are arranged. The cooling liquid contact portion 10 is arranged within the housing so that it can contact a cooling liquid located in the housing in order to establish an electrical connection. The rivet element 5 is tangentially surrounded by the cooling liquid.

The passage opening 4 further comprises a region having a recess 11, which is configured to receive a sealing element.

In the present exemplary embodiment, the sealing element is configured as an O-ring 12. The O-ring 12 provides an additional seal for the rivet connection. The inner diameter of the O-ring 12 corresponds approximately to the outer diameter of the rivet sleeve 9. The diameter of the recess 11 corresponds approximately to the outer diameter of the O-ring 12.

Furthermore, according to the present disclosure, a coolant-conducting component, in particular for motor vehicles, is provided.

It comprises a ground-connection apparatus 1, which comprises a housing 2, a ground connector 7, and a rivet element 5, wherein the rivet element 5 comprises a cooling liquid contact portion 10, a fastening portion 3, and a ground connection portion 6 along its longitudinal axis L.

A first end 13 of the rivet element 5 forms the cooling liquid contact portion 10, which is arranged within the housing 2 such that it can contact a cooling liquid located in the housing 2 in order to establish an electrical connection with a cooling liquid.

The fastening portion 3 is tangentially surrounded by the housing 2 in the region of the passage opening 4.

The ground connection portion 6 is connected to the ground connector 7 in such a way that an electrical connection is established between the ground connector 7 and the rivet element 5, and the rivet element 5 is connected by deformation to the housing 2 in the region of the passage opening 4 via the fastening portion 3.

In addition, according to the present disclosure, a method for connecting coolant-conducting components is provided.

It comprises a ground-connection apparatus 1, which comprises a housing 2, a ground connector 7, and a rivet element 5, wherein the rivet element 5 comprises a cooling liquid contact portion 10, a fastening portion 3, and a ground connection portion 6 along its longitudinal axis L.

A first end 13 of the rivet element 5 forms the cooling liquid contact portion 10, which is arranged within the housing 2 such that it can contact a cooling liquid located in the housing 2 in order to establish an electrical connection with a cooling liquid. The fastening portion 3 is tangentially surrounded by the housing 2 in the region of the passage opening 4.

The ground connection portion 6 is connected to the ground connector 7 in such a way that an electrical connection is established between the ground connection direction 7 and the rivet element 5, and the rivet element 5 is connected by deformation to the housing 2 in the region of the passage opening 4 via the fastening portion 3.

To assemble the ground-connection apparatus 1, the rivet sleeve 9 is inserted into the ground connector 7, into the O-ring 12, and then into the passage opening 4 from the outside into the housing 2 so that the rivet element 5 projects into the housing at a first end 13.

With a rivet pin or riveter, the rivet needle is pulled out of the rivet sleeve 9 so that the rivet sleeve 9 causes a plastic deformation in the interior of the housing 2.

In this way, the rivet element 5, ground connector 7, O-ring 12, and housing 2 are mechanically connected to one another along the longitudinal axis L. (FIG. 1 and FIG. 2)

Such a rivet connection can be re-soldered or glued in order to establish a better electrical contact and/or in order to be particularly leak resistant.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Ground-connection apparatus
2 Housing
3 Fastening portion
4 Passage opening
5 Rivet element
6 Ground connection portion
7 Ground connector
8 Opening
9 Rivet sleeve
10 Cooling liquid contact portion
11 Recess
12 O-ring
13 First end of the rivet element
L Longitudinal axis

What is claimed is:

1. A ground-connection apparatus (1) for coolant-conducting components in motor vehicles, comprising:
a coolant-conducting component having a housing (2) which is not or only poorly electrically conductive and comprises a passage opening (4) for receiving an electrically conductive rivet element (5); and
an electrically conductive ground connector (7), which is connectable to a ground at a first end and has an opening for the rivet element (5) at a second end,
wherein the rivet element (5) along its longitudinal axis (L) comprises a cooling liquid contact portion (10), a fastening portion (3), and a ground connection portion (6),
wherein a first end of the rivet element (5) forms the cooling liquid contact portion (10), which is arranged within the housing (2) in such a way that it can contact a cooling liquid located in the housing (2) in order to establish an electrical connection with a cooling liquid,
wherein the fastening portion (3) is, in regions, tangentially surrounded by the housing (2) in the region of the passage opening (4), and
wherein the ground connection portion (6) is connected to the ground connector (7) in such a way that an electrical connection is established between the ground connector (7) and the rivet element (5), and the rivet element (5) is retained in the passage opening (4) in that it has been deformed.

2. The ground-connection apparatus (1) according to claim 1, wherein the rivet element (5) is sealingly connected to an edge of the housing (2) which delimits the passage opening (4) by the deformation of the rivet element (5) and/or by a sealing element.

3. The ground-connection apparatus (1) according to claim 2, wherein the housing (2) is configured in the region of the passage opening (4) to have a sealing recess for receiving the sealing element, and wherein a sub-portion of the fastening portion (3) of the rivet element (5) forms a sealing portion.

4. The ground-connection apparatus (1) according to claim 1, wherein the ground connector (7) is formed from a sheet metal, which can also be used for shielding purposes.

5. The ground-connection apparatus (1) according to claim 1, wherein the ground connector (7) is formed from an insulated cable and a cable lug.

6. The ground-connection apparatus (1) according to claim 1, wherein the housing (2) is made of a plastic by means of a single-component injection molding process.

7. The ground-connection apparatus (1) according to claim 1, wherein the coolant-conducting components are configured as valves, valve housings, radiators, pumps, conduits, reservoir tanks, and/or battery housings.

8. The ground-connection apparatus (1) according to claim 1, wherein in addition to the ground connector (7) in the ground connection portion (6), other components independent of the coolant guidance can be connected to the ground by the rivet element (5).

9. The ground-connection apparatus (1) according to claim 1, wherein the electrically conductive rivet element (5) is a blind rivet.

10. The ground-connection apparatus (1) according to claim 1, wherein the sealing element is an O-ring (12).

11. The ground-connection apparatus (1) according to claim 1, wherein the sheet metal is copper or aluminum.

12. A coolant-conducting component, comprising a ground-connection apparatus (1), in particular according to claim 1, which comprises a housing (2), a ground connector (7), and a rivet element (5), wherein a first end of the rivet element (13) forms the cooling liquid contact portion (10), which is arranged within the housing (2) in such a way that it can contact a cooling liquid located in the housing (2) in order to establish an electrical connection with a cooling liquid, and wherein the fastening portion (3) is, in regions, tangentially surrounded by the housing (2) in the region of the passage opening (4), and wherein the ground connection portion (6) is connected to the ground connector (7) in such a way that an electrical connection is established between the ground connector and the rivet element (5), and the rivet element (5) is connected by deformation to the housing (2) in the region of the passage opening (4) via the fastening portion (3).

13. A method for connecting coolant in coolant-conducting components to a ground, comprising a ground-connection apparatus (1) according to claim 1, which comprises a housing (2), a ground connector (7), and a rivet element (5), wherein a first end of the rivet element (13) forms the cooling liquid contact portion (10), which is arranged within the housing (2) in such a way that it can contact a cooling liquid located in the housing (2) in order to establish an electrical connection with a cooling liquid, and wherein the fastening portion (3) is, in regions, tangentially surrounded by the housing (2) in the region of the passage opening (4), and wherein the ground connection portion (6) is connected to the ground connector (7) in such a way that an electrical connection is established between the ground connector and the rivet element (5), and the rivet element (5) is connected by deformation to the housing (2) in the region of the passage opening (4) via the fastening portion (3).
